(19) United States
(12) Patent Application Publication
(10) Pub. No.: US 2011/0122462 A1
(43) Pub. Date: May 26, 2011

(54) IMAGE READING APPARATUS, CONTROL METHOD FOR THE SAME, AND IMAGE FORMING APPARATUS

(75) Inventor: Hirokazu Shoda, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/872,019

(22) Filed: Aug. 31, 2010

Related U.S. Application Data
(60) Provisional application No. 61/263,480, filed on Nov. 23, 2009.

(51) Int. Cl. H04N 1/04

(52) U.S. Cl. 358/498; 358/474

(57) ABSTRACT

According to one embodiment, a scanning unit feeds a document to a scanning window, passes the document over the scanning window, and reads an image of the passing document by optical line scan through the scanning window. When the scanning unit operates, whether the image read by the scanning unit includes one or plural images of adhering matter in the scanning window is detected. When the image of adhering matter is included, the image of adhering matter is removed from the image read by the scanning unit.

### CROSS-REFERENCE TO RELATED APPLICATIONS

This application is based upon and claims the benefit of priority from U.S. Provisional Application No. 61/263,480, filed on Nov. 23, 2009, the entire contents of which are incorporated herein by reference.

### FIELD

Embodiments described herein relate generally to an image reading apparatus which optically reads an image on a document, a control method for the same, and an image forming apparatus.

### BACKGROUND

An image forming apparatus, for example, a copier has an image reading apparatus or so-called scanning unit including an automatic document feeder (ADF). In this scanning unit, plural sheets of documents set on a tray are fed one by one to a scanning window and passed over the scanning window. Thus, an image on the passing document is read by optical line scan through the scanning window.

A glue of a sticker tag may be adhering to a document. When this document is fed to the scanning window by the automatic document feeder, the glue adhering to the document adheres to the scanning window. Also, ink and dust on the document may adhere to the glue adhering to the scanning window.

As the glue, ink, dust and the like are adhering to the scanning window, the scanned image includes an image of unwanted stripes.

### BRIEF DESCRIPTION OF THE DRAWINGS

FIG. 1 shows the configuration of an embodiment.

FIG. 2 shows a document plate, a scanning window and an exposure lamp in the embodiment.

FIG. 3 is a block diagram showing a control circuit in the embodiment.

FIG. 4 is a block diagram showing an image processing unit shown in FIG. 3.

FIG. 5 shows an arrangement of pixels of a read image in the embodiment.

FIG. 6 shows an average value calculated by an adhering matter detecting section in the embodiment.

FIG. 7 is a view for explaining linear interpolation by an adhering matter removing section in the embodiment.

FIG. 8 shows R, G, B pixels of image data including “image data based on adhering matter” in the embodiment.

FIG. 9 is a flowchart showing the control of a CPU in the embodiment.

### DETAILED DESCRIPTION

In general, according to one embodiment, an image reading apparatus includes: a scanning unit which feeds a document to a scanning window, passes the document over the scanning window, and reads an image of the passing document by optical line scan through the scanning window; an adhering matter detecting section which detects whether the image read by the scanning unit includes one or plural images of adhering matter in the scanning window or not, when the scanning unit operates; and an adhering matter removing section which removes the image of the adhering matter from the image read by the scanning unit when a result of the detection by the adhering matter detecting section is positive.

Hereinafter, an embodiment will be described with reference to the drawings.

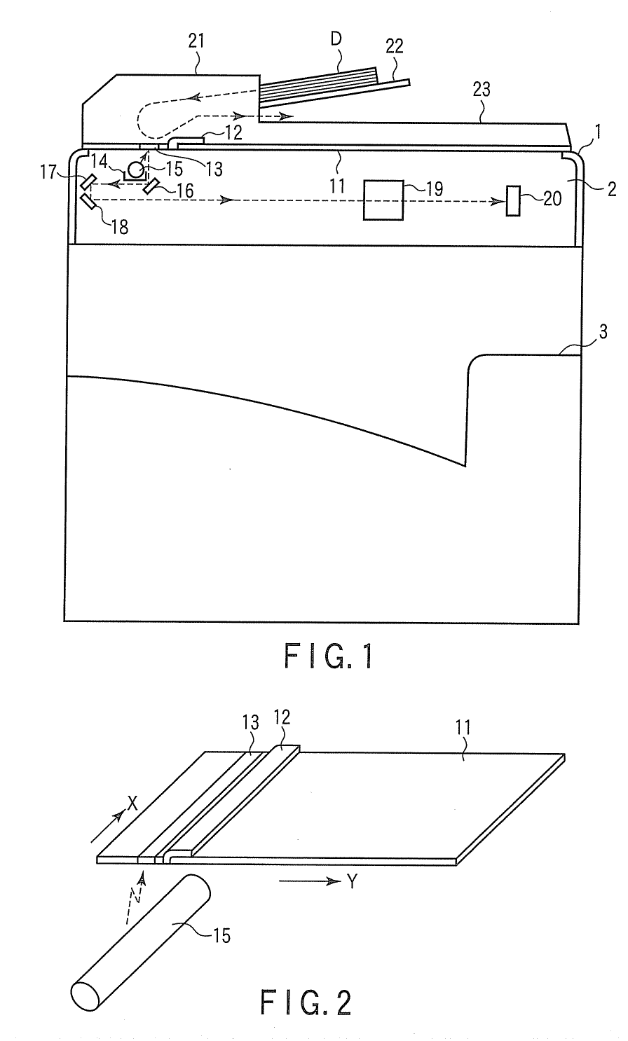

As shown in FIG. 1 and FIG. 2, a scanning unit 2 is arranged in an upper part of a body 1. The scanning unit 2 has a transparent document plate 11 to set a document on. The document plate 11 has an indicator 12. An edge of the indicator 12 serves as a reference position for setting a document. A scanning window 13 is arranged at a position near the indicator 12 in the document plate 11 and along the direction of the width of the document plate 11.

A carriage 14 is provided to the lower side of the document plate 11. An exposure lamp 15 is provided in the carriage 14. The carriage 14 reciprocates along the lower side of the document plate 11. As the exposure lamp 15 turns on while the carriage 14 moves forward along the document plate 11, a document D placed on the document plate 11 is exposed to light. With this exposure, a reflected light image from the document D is acquired. This reflected light image is projected to an image data output unit, for example, a CCD (charge coupled device) sensor 20, by reflection mirrors 16, 17 and 18 and a variable-power lens block 19.

The CCD sensor 20 performs line scan with the received light along the axial direction of the exposure lamp 15 and thus outputs red image data R, green image data G, blue image data B and black image data BK corresponding to the image of the document D. The CCD sensor 20 repeats this line scan as the carriage 14 moves forward. The direction of the line scan by the CCD sensor 20 is a main scanning direction X. The direction of the forward movement of the carriage 14 is a sub scanning direction Y.

An automatic document feeder (ADF) 21 which also serves as a cover is arranged over the document plate 11, the indicator 12 and the scanning window 13 in such a manner that the automatic document feeder 21 can freely open and close. The automatic document feeder 21 feeds the document D including plural sheets set on a tray 22 to the scanning window 13 sheet by sheet, then passes the document over the scanning window 13, and discharges the passed document D to a tray 23. When the automatic document feeder 21 operates, the exposure lamp 15 emits light at a position corresponding to the scanning window 13 and the light is cast through the scanning window 13 onto the document D passed over the scanning window 13. The document D passing over the scanning window 13 is exposed by the casting. A reflected light image acquired by this exposure is projected to the CCD sensor 20 by the reflection mirrors 16, 17 and 18 and the variable-power lens block 19.

The document plate 11, the scanning window 13, the carriage 14, the exposure lamp 15, the reflection mirrors 16, 17 and 18, the variable-power lens block 19, the CCD sensor 20, and the automatic document feeder 21 constitute the scanning unit 2. The scanning window 13, the carriage 14, the exposure lamp 15, the reflection mirrors 16, 17 and 18, the variable-power lens block 19, and the CCD sensor 20 constitute an exposure unit for the automatic document feeder 21. That is, the exposure unit for the automatic document feeder 21 casts the light of the exposure lamp 15 through the scanning window 13 onto the document D passing over the scanning window 13, then projects the reflected light image from the document D to the CCD sensor 20 via the reflection mirrors 16, 17 and 18 and the variable-power lens block 19, and reads the image of the document D by repeating the line scan by the CCD sensor 20.

A printing unit 3 is provided below the scanning unit 2 in the body 1. The printing unit 3 prints an image read by the exposure unit onto a sheet.

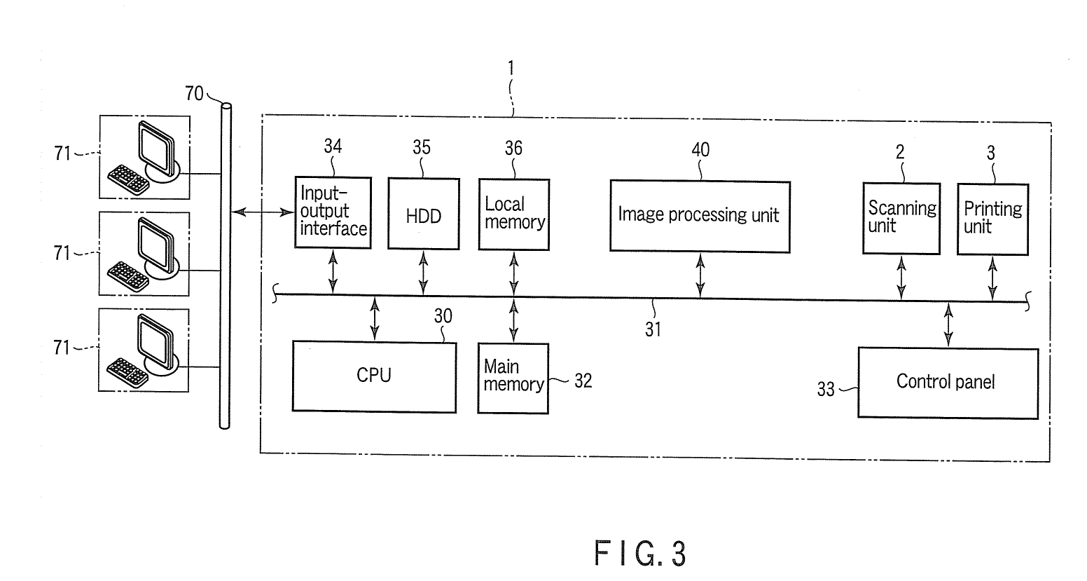

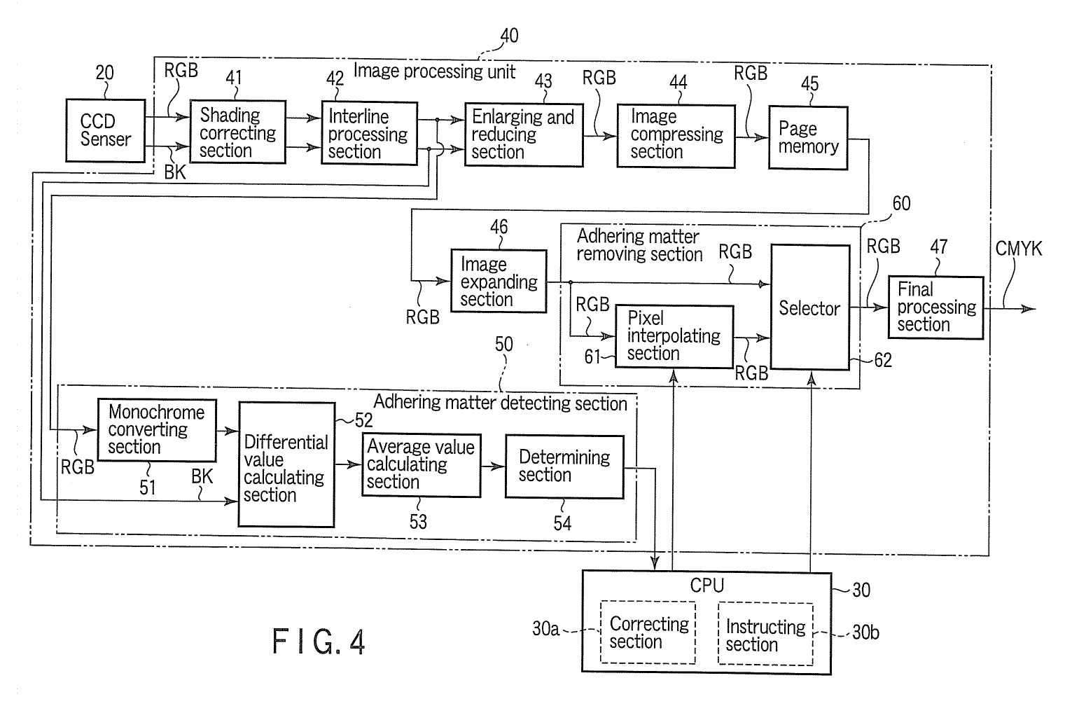

FIG. 3 shows a control circuit in the body 1.

A bus 31 is connected to a CPU 30 as a main control unit. The scanning unit 2, the printing unit 3, a main memory 32, a control panel 33, an input-output interface 34, a hard disk drive (HDD) 35, a local memory 36, and an image processing unit 40 are connected to the bus 31. The control panel 33 is for the user to set operation conditions. The local memory 36 is for temporarily storing image data that is processed by the image processing unit 40. Plural client terminals, for example, personal computers 71 are connected to the input-output interface 34 via a network cable 70.

The image processing unit 40 includes a shading correcting section 41, an interline processing section 42, an enlarging and reducing section 43, an image compressing section 44, a page memory 45, an image expanding section 46, a final processing section 47, an adhering matter detecting section 50, and an adhering matter removing section 60 or the like.

The shading correcting section 41 corrects the shading of the image data R, G, B and BK outputted from the CCD sensor 20. The interline processing section 42 performs interline processing of the image data R, G, B and BK that shading-corrected by the shading correcting section 41. The enlarging and reducing section 43 enlarges or reduces the image data R, G, B and BK that are processed by the interline processing section 42. The image compressing section 44 compresses the image data R, G, B and BK that are enlarged or reduced by the enlarging and reducing section 43. The page memory 45 sequentially and temporarily stores the image data R, G, B equivalent to one page that are compressed by the image compressing section 44, and properly executes rotation of the temporarily stored image data R, G, B equivalent to one page in response to an instruction from the CPU 30. The image expanding section 46 expands the image data R, G, B equivalent to one page in the page memory 45. The final processing section 47 performs final processing of the image data R, G, B equivalent to one page that are processed by the adhering matter removing section 60, such as color conversion, filtering, and gradation processing.

The adhering matter detecting section 50 is for detecting whether the image data R, G, B and BK processed by the interline processing section 42 include one or plural image data of adhering matter in the scanning window 13. The adhering matter detecting section 50 includes a monochrome converting section 51, a differential value calculating section 52, an average value calculating section 53, and a determining section 54. The adhering matter is, for example, glue, ink, dust and the like.

The monochrome converting section 51 converts the image data R, G, B processed by the interline processing section 42 to one monochrome data P by calculating “(image data R+image data G+image data B)/3” when the scanning unit 2 operates.

The differential value calculating section 52 calculates the differential value (absolute value) between the monochrome data P converted by the monochrome converting section 51 and the black image data BK processed by the interline processing section 42, for each pixel in the read image equivalent to one page, when the reading of the image equivalent to one page by the scanning unit 2 is completed.

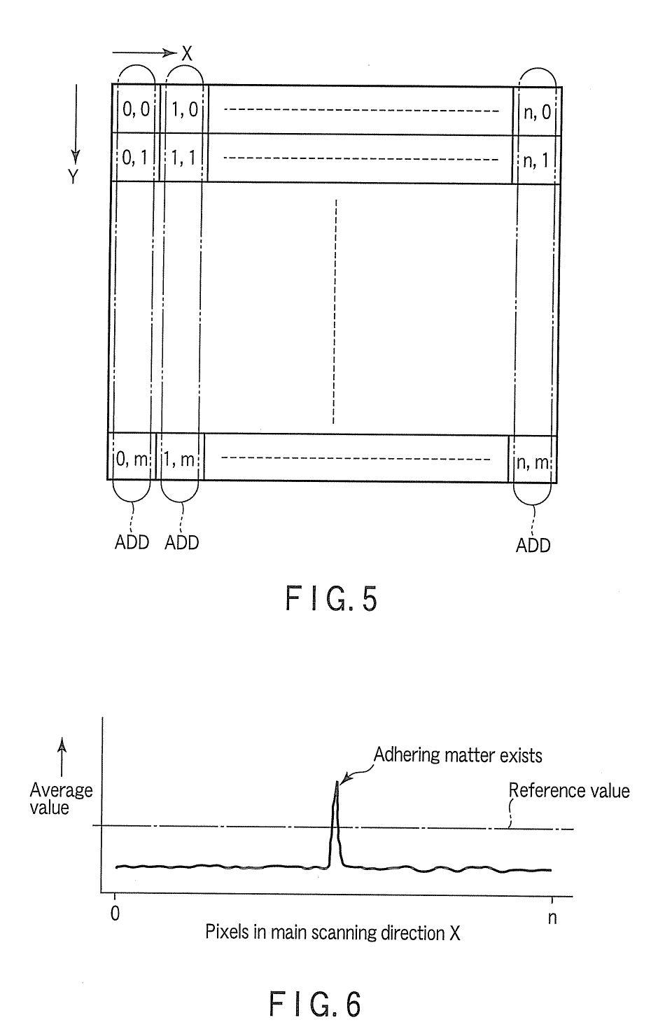

The read image equivalent to one page is acquired as the line scan (in the main scanning direction X) of n pixels by the CCD sensor 20 is repeated for m lines in the sub scanning direction Y, as shown in FIG. 5. That is, the pixels of the image data R, G, B and BK acquired by the line scan on the first line are n pixels from the coordinate value “0, 0” corresponding to the first pixel on the CCD sensor 20 to “n, 0” corresponding to the n-th pixel on the CCD sensor 20. The pixels of the image data R, G, B and BK acquired by the line scan on the second line are n pixels from the coordinate value “0, 1” corresponding to the first pixel on the CCD sensor 20 to “n, 1” corresponding to the n-th pixel on the CCD sensor 20. The pixels of the image data R, G, B and BK acquired by the line scan on the m-th line are n pixels from the coordinate value “0, m” corresponding to the first pixel on the CCD sensor 20 to “n, m” corresponding to the n-th pixel on the CCD sensor 20.

The differential value calculating section 52 calculates the differential value (absolute value) P between the monochrome data P and the black image data BK for each of the “n×m” pixels. That is, when the monochrome data P of the pixel with the coordinate value “0, 0” is P00 and the black image data BK of the pixel with the same coordinate value “0, 0” is BK00, the differential value calculating section 52 calculates “P00−BK00” to find the differential value Q00 of the pixel with the coordinate value “0, 0”. When the image data R, G, B of the pixel with the coordinate value “0, 0” includes no “image data of adhering matter”, the monochrome data P00 is equal to the black image data BK00. When the image data R, G, B of the pixel with the coordinate value “0, 0” includes “image data of adhering matter”, there is a difference between the monochrome data P00 and the black image data BK00.

Similarly, when the monochrome data P of the pixel with the coordinate value “1, 0” is P10 and the black image data BK of the pixel with the same coordinate value “1, 0” is BK10, the differential value calculating section 52 calculates “P10−BK10” to find the differential value Q10 of the pixel with the coordinate value “1, 0”. When the monochrome data P of the pixel with the coordinate value “n, 0” is Pn0 and the black image data BK of the pixel with the same coordinate value “n, 0” is BKn0, the differential value calculating section 52 calculates “Pn0−BKn0” to find the differential value Qn0 of the pixel with the coordinate value “n, 0”. When the monochrome data P of the pixel with the coordinate value “0, 1” is P01 and the black image data BK of the pixel with the same coordinate value “0, 1” is BK01, the differential value calculating section 52 calculates “P01−BK01” to find the differential value Q01 of the pixel with the coordinate value “0, 1”. When the monochrome data P of the pixel with the coordinate value “1, 1” is P11 and the black image data BK of the pixel with the same coordinate value “1, 1” is BK11, the differential value calculating section 52 calculates “P11−BK11” to find the differential value Q11 of the pixel with the coordinate value “1, 1”. When the monochrome data P of the pixel with the coordinate value “n, 1” is Pn1 and the black image data BK of the pixel with the same coordinate value “n, 1” is BKn1, the differential value calculating section 52 calculates “Pn1−BKn1” to find the differential value Qn1 of the pixel with the coordinate value “n, 1”.

When the reading of the image equivalent to one page by the scanning unit 2 is completed, the average value calculating section 53 adds the differential values Q calculated by the differential value calculating section 52, by each pixel in the direction of the line scan by the CCD sensor 20 (the main scanning direction X) and divides the “added value by pixel” by the number of lines in the line scan for one page by the CCD sensor 20. Thus, the average value calculating section 53 calculates the “average value of differential values by pixel” in the direction of the line scan by the CCD sensor 20.

That is, the m “differential values by pixel” for the coordinate values “0, 0”, “0, 1”, . . . “0, m” corresponding to the first pixel on the CCD sensor 20 are added along the sub scanning direction Y, as indicated by double-dotted chain lines surrounding the coordinates values in FIG. 5. As the “differential value by pixel” is divided by the number of lines “m” in the line scan for one page by the CCD sensor 20, the “average value of differential values by pixel” corresponding to the first pixel on the CCD sensor 20 is calculated. Also, the m “differential values by pixel” for the coordinate values “1, 0”, “1, 1”, . . . “1, m” corresponding to the second pixel on the CCD sensor 20 are added along the sub scanning direction Y. As the “differential value by pixel” is divided by the number of lines “m”, the “average value of differential values by pixel” corresponding to the second pixel on the CCD sensor 20 is calculated. Similarly, the m “differential values by pixel” for the coordinate values “n, 0”, “n, 1”, . . . “n, m” corresponding to the n-th pixel on the CCD sensor 20 are added along the sub scanning direction Y. As the “differential value by pixel” is divided by the number of lines “m”, the “average value of differential values by pixel” corresponding to the n-th pixel on the CCD sensor 20 is calculated.

The determining section 54 determines whether any of the image data of each pixel in the direction of the line scan by the CCD sensor 20 includes the “image data of adhering matter” or not, on the basis of the “average value of differential values by pixel” calculated by the average value calculating section 53. When the result of this determination is positive, the determining section 54 determines the pixel of the image data including the “image data of adhering matter”. The CPU 30 receives the result of the determination by the determining section 54.

FIG. 6 shows the “average value of differential values by pixel” calculated by the average value calculating section 53, in association with each pixel on the CCD sensor 20. When adhering matter exists in the scanning window 13, any of the calculated “average values of differential values by pixel” exceeds a reference value. The pixel having the “average value of differential values by pixel” exceeding the reference value is the pixel in the image data R, G, B that includes the “image data of adhering matter”.

When the result of the detection by the adhering matter detecting section 50 is positive, the adhering matter removing section 60 removes the image data of adhering matter from the image data R, G, B equivalent to one page that is expanded by the image expanding section 46. Specifically, when it is determined by the determining section 54 that any of the image data R, G, B of each pixel in the direction of the line scan by the CCD sensor 20 includes the “image data of adhering matter” and the pixel of the image data R, G, B including the “image data of adhering matter” is determined by the determining section 54, the adhering matter removing section 60 corrects the image data R, G, B of the determined pixel to image data R, G, B that does not include the “image data of adhering matter” by linear interpolation. The adhering matter removing section 60 includes a pixel interpolating section 61 and a selector 62. The adhering matter removing section 60 grasps the result of each determination by the determining section 54 on the basis of a notification from the CPU 30.

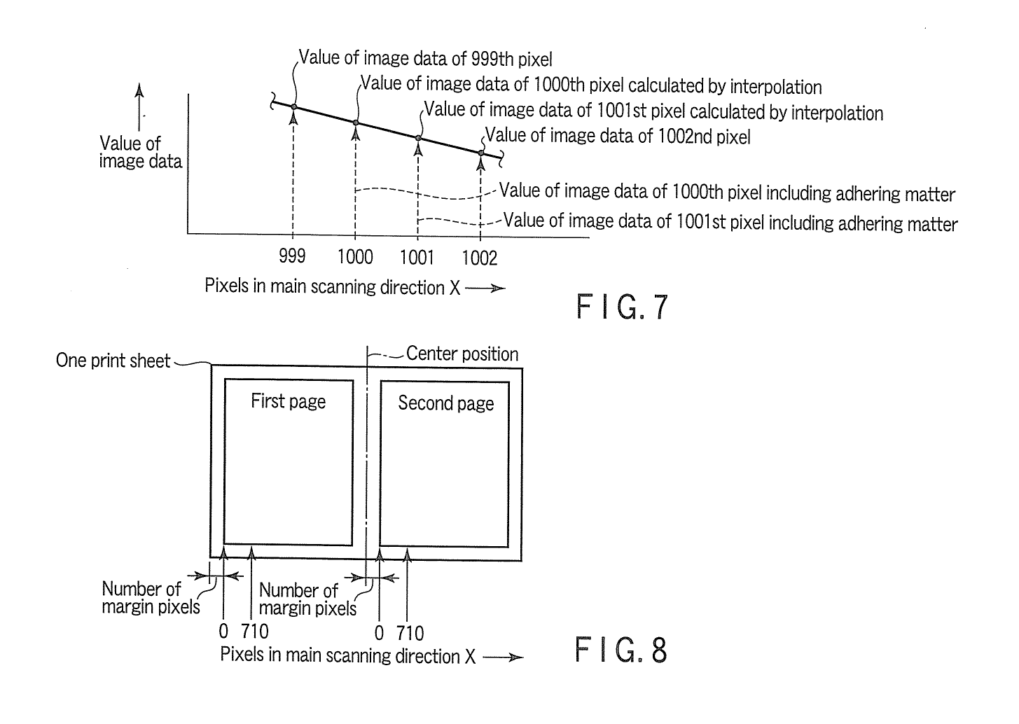

The pixel interpolating section 61 grasps the pixel of the image data R, G, B including the “image data of adhering matter” on the basis of a notification from the CPU 30 and corrects the image data R, G, B of the grasped pixel to image data R, G, B that does not include the “image data of adhering matter” by linear interpolation. FIG. 7 shows how this correction is carried out. When the pixel of the image data R, G, B including the “image data of adhering matter” is the 1000^{th} pixel and the 1001^{st} pixel, the image data R, G, B of the 1000^{th} pixel are corrected to image data R, G, B that does not include the “image data of adhering matter” and the image data R, G, B of the 1001^{st} pixel is corrected to image data R, G, B that does not include the “image data of adhering matter”, by linear interpolation using the value of the image data R, G, B of the neighboring 999^{th} pixel and the value of the image data R, G, B of the neighboring 1002^{nd} pixel.

The selector 62 selects and outputs either the image data R, G, B expanded by the image expanding section 46 or the image data R, G, B corrected by the pixel interpolating section 61 on the basis of an instruction from the CPU 30.

The CPU 30 has a correcting section 30a and an instructing section 30b as its main functions. When one kind of processing of enlargement, reduction, and rotation by the enlarging and reducing section 43 is carried out to the image read by the scanning unit 2, the correcting section 30a corrects the pixel of the image data R, G, B including the “image data of adhering matter” determined by the determining section 54, along the performed processing. The instructing section 30b notifies the pixel interpolating section 61 of the result of the correction by the correcting section 30a. Also, when it is determined by the determining section 54 that the “image data of adhering matter” is included, the instructing section 30b instructs the selector 62 to selectively output the image data R, G, B corrected by the pixel interpolating section 61. When it is not determined by the determining section 54 that the “image data of adhering matter” is included, the instructing section 30b instructs the selector 62 to selectively output the image data R, G, B expanded by the image expanding section 46.

The enlarging and reducing section 43 changes the magnifying power in the main scanning direction X within the range of 25 to 400% in accordance with a magnifying power setting operation on the control panel 33. Where the maximum number of pixels that can be printed in the main scanning direction X with the magnifying power of 100% in the main scanning direction X is 7000 and the pixel of the image data R, G, B including “image data of adhering matter” is, for example, the 1000^{th} pixel, when the magnifying power of 25% is set on the control panel 33, the correcting section 30a of the CPU 30 corrects the pixel of the image data R, G, B including the “image data of adhering matter” to the 250^{th} pixel by calculating “1000×0.25”. When the magnifying power of 141% is set on the control panel 33, the correcting section 30a of the CPU 30 corrects the pixel of the image data R, G, B including the “image data of adhering matter” to the 1410^{th} pixel by calculating “1000×1.41”. However, when the position of the corrected pixel exceeds the maximum number of pixels 7000, the correcting section 30a of the CPU 30 determines that there is no adhering matter, as exceptional processing, and notifies the adhering matter removing section 60 of this processing. When the position of the corrected pixel exceeds the maximum number of pixels 7000, there is no problem because an unwanted image due to the adhering matter is not printed.

When the image data R, G, B equivalent to one page in the page memory 45 is rotated by 90 degrees to the right and the pixel of the image data R, G, B including “image data of adhering matter” is the 1000^{th} pixel, the correcting section 30a of the CPU 30 corrects the pixel of the image data R, G, B including the “image data of adhering matter” to the 1000^{th} pixel in the sub scanning direction Y in the read image shown in FIG. 5. When the image data R, G, B equivalent to one page in the page memory 45 is rotated by 180 degrees to the right and the pixel of the image data R, G, B including “image data of adhering matter” is the 1000^{th} pixel, the correcting section 30a of the CPU 30 corrects the pixel of the image data R, G, B including the “image data of adhering matter” to the 6000^{th} pixel by calculating “the maximum number of pixels 7000-1000”. When the image data R, G, B equivalent to one page in the page memory 45 is rotated by 270 degrees to the right and the pixel of the image data R, G, B including “image data of adhering matter” is the 1000^{th} pixel, the correcting section 30a of the CPU 30 corrects the pixel of the image data R, G, B including the “image data of adhering matter” to the “maximum number of pixels in the sub scanning direction Y−1000”th pixel in the read image shown in FIG. 5 by calculating “the maximum number of pixels in the sub scanning direction Y−1000”.

In the 2 in 1 mode where images equivalent to two pages are to be printed on one print sheet, the magnifying power is 71% and therefore, for the image of the first page, the correcting section 30a of the CPU 30 corrects the pixel of the image data R, G, B including “image data of adhering matter” to the “number of margin pixels+710”th pixel by calculating “the number of margin pixels+1000×0.71”, as shown in FIG. 8. For the image of the second page, the correcting section 30a corrects the pixel of the image data R, G, B including “image data of adhering matter” to the “number of pixels at the center position+the number of margin pixels+710”th pixel by calculating “the number of pixels at the center position+the number of margin pixels+1000×0.71”.

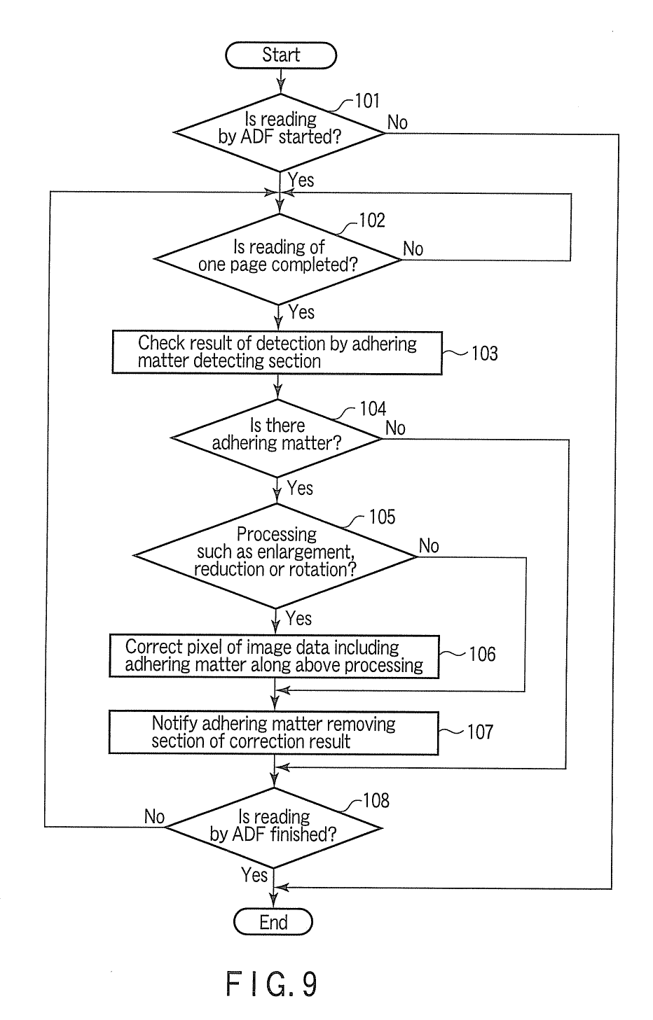

As the automatic document feeder 21 starts reading (YES in ACT 101) and the reading of an image equivalent to one page is completed (YES in ACT 102), the CPU 30 checks the result of the detection by the adhering matter detecting section 50 (ACT 103), as shown in the flowchart of FIG. 9. When the result of the detection by the adhering matter detecting section 50 shows that there is adhering matter (YES in ACT 104) and processing such as enlargement, reduction or rotation is carried out (YES in ACT 105), the CPU 30 corrects the pixel of the image data R, G, B including “image data of adhering matter” along that processing (ACT 106). The CPU 30 then notifies the adhering matter removing section 60 of the result of the correction (ACT 107). The CPU 30 repeats the processing of ACT 102 to ACT 107 until the reading by the automatic document feeder 21 ends (YES in ACT 101).

As described above, when the scanning unit 2 operates, whether an image read by the scanning unit 2 includes one or plural images of adhering matter in the scanning window 13 is detected. When an image of adhering matter is included, the image of adhering matter is removed from the image read by the scanning unit 2. Thus, even when glue, ink or dust is adhering to the scanning window 13, an unwanted stripe image due to the adhering matter is not printed.

The subjective bodies performing the operations are associated with a computer such as hardware, a combination of hardware and software, software, and software in operation. Although the subjective bodies performing the operations are, for example, processes, processors, object-executing files, threads, programs, and computers, the invention is not limited to these subjective bodies. For example, an image reading apparatus or an application executed therein may be the subjective body performing the operations. The plural subjective bodies performing the operations may be distributed to a process or a thread. The subjective bodies performing the operations may exist in a single image reading apparatus, or may be distributed to plural image reading apparatuses.

Although the functions putting the invention into practice are recorded in advance in the apparatus in this embodiment, the invention is not limited to this configuration. The functions may be downloaded onto the apparatus from a network, or a recording medium storing the functions may be installed in the apparatus. The type of the recording medium is not particularly limited, as long as it is a recording medium which can store programs and which can be read by the apparatus, such as a CD-ROM. The functions obtained by the installation or the download in advance may be embodied in cooperation with the OS (operating system) of the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading apparatus comprising:
a scanning unit which feeds a document to a scanning window, passes the document over the scanning window, and reads an image of the passing document by optical line scan through the scanning window;
an adhering matter detecting section which detects whether the image read by the scanning unit includes one or plural images of adhering matter in the scanning window or not, when the scanning unit operates; and
an adhering matter removing section which removes the image of the adhering matter from the image read by the scanning unit when a result of the detection by the adhering matter detecting unit is positive.

2. The apparatus of claim 1, wherein the scanning unit includes:
an automatic document feeder which feeds a document including plural sheets set on a document setting tray to the scanning window, sheet by sheet, then passes the document over the scanning window, and discharges the passed document to a discharge tray; and
an exposure unit which casts light of an exposure lamp through the scanning window to the document passed over the scanning window, projects a reflected light image form the document to a CCD sensor for the line scan, and reads an image of the document by repeating the line scan by the CCD sensor.

3. The apparatus of claim 2, wherein the CCD sensor outputs red image data R, green image data G, blue image data B, and black image data BK.

4. The apparatus of claim 3, wherein the adhering matter detecting section includes:
a monochrome converting section which converts the red image data R, the green image data G and the blue image data B outputted from the CCD sensor to one monochrome data when the scanning unit operates;
a differential value calculating section which, when reading of an image equivalent to one page by the scanning unit is completed, calculates a differential value between the monochrome data converted by the monochrome converting section and the black image data BK outputted from the CCD sensor, for each pixel in the read image equivalent to one page;
an average value calculating section which, when reading of an image equivalent to one page by the scanning unit is completed, adds each differential value calculated by the differential value calculating section, by each pixel in the direction of the line scan by the CCD sensor and divides the “added value by pixel” by the number of lines in the line scan for one page by the CCD sensor, thus calculating an “average value of differential values by pixel” in the direction of the line scan by the CCD sensor; and
a determining section which determines whether any of the image data of each pixel in the direction of the line scan by the CCD sensor includes the “image data of adhering matter” or not, on the basis of the “average value of differential values by pixel” calculated by the average value calculating section, and when the result of the determination is positive, determines a pixel of the image data including the “image data of adhering matter”.

5. The apparatus of claim 4, wherein when it is determined by the determining section that any of the image data of each pixel in the direction of the line scan by the CCD sensor includes the “image data of adhering matter” and the pixel of the image data including the “image data of adhering matter” is determined by the determining section, the adhering matter removing section corrects the image data of the determined pixel to image data that does not include the “image data of adhering matter” by linear interpolation.

6. The apparatus of claim 5, further comprising a control section which, when one kind of processing of enlargement, reduction, and rotation is carried out to the image read by the scanning unit, corrects the pixel of the image data including the “image data of adhering matter” determined by the determining section, along the performed processing.

7. A control method for an image reading apparatus having a scanning unit which feeds a document to a scanning window, passes the document over the scanning window, and reads an image of the passing document by optical line scan through the scanning window, the method comprising:
detecting whether the image read by the scanning unit includes one or plural images of adhering matter in the scanning window or not, when the scanning unit operates; and
removing the image of the adhering matter from the image read by the scanning unit when a result of the detection is positive.

8. The method of claim 7, wherein the scanning unit includes:
an automatic document feeder which feeds a document including plural sheets set on a document setting tray to the scanning window, sheet by sheet, then passes the document over the scanning window, and discharges the passed document to a discharge tray; and
an exposure unit which casts light of an exposure lamp through the scanning window to the document passed over the scanning window, projects a reflected light image from the document to a CCD sensor for the line scan, and reads an image of the document by repeating the line scan by the CCD sensor.

9. The method of claim 8, wherein the CCD sensor outputs red image data R, green image data G, blue image data B, and black image data BK.

10. The method of claim 9, wherein the “detecting” includes:
converting the red image data R, the green image data G and the blue image data B outputted from the CCD sensor to one monochrome data when the scanning unit operates;
when reading of an image equivalent to one page by the scanning unit is completed, calculating a differential value between the converted monochrome data and the black image data BK outputted from the CCD sensor, for each pixel in the read image equivalent to one page;
when reading of an image equivalent to one page by the scanning unit is completed, adding each calculated differential value by each pixel in the direction of the line scan by the CCD sensor and dividing the “added value by pixel” by the number of lines in the line scan for one page by the CCD sensor, thus calculating an “average value of differential values by pixel” in the direction of the line scan by the CCD sensor; and
determining whether any of the image data of each pixel in the direction of the line scan by the CCD sensor includes the “image data of adhering matter” or not, on the basis of the calculated “average value of differential values by pixel”, and when the result of the determination is positive, determining a pixel of the image data including the “image data of adhering matter”.

11. The method of claim 10, wherein the “removing” includes, when it is determined in the “determining” that any of the image data of each pixel in the direction of the line scan by the CCD sensor includes the “image data of adhering matter” and the pixel of the image data including the “image data of adhering matter” is determined by the “determining”, correcting the image data of the determined pixel to image data that does not include the “image data of adhering matter” by linear interpolation.

12. The method of claim 11, further comprising, when one kind of processing of enlargement, reduction, and rotation is carried out to the image read by the scanning unit, correcting the pixel of the image data including the “image data of adhering matter” determined by the “determining”, along the performed processing.

13. An image forming apparatus comprising:
a scanning unit which feeds a document to a scanning window, passes the document over the scanning window, and reads an image of the passing document by optical line scan through the scanning window;
an adhering matter detecting section which detects whether the image read by the scanning unit includes one or plural images of adhering matter in the scanning window or not, when the scanning unit operates;
an adhering matter removing section which removes the image of the adhering matter from the image read by the scanning unit when a result of the detection by the adhering matter detecting unit is positive; and
a printing unit which prints the image read by the scanning unit.

14. The apparatus of claim 13, wherein the scanning unit includes:
an automatic document feeder which feeds a document including plural sheets set on a document setting tray to the scanning window, sheet by sheet, then passes the document over the scanning window, and discharges the passed document to a discharge tray; and
an exposure unit which casts light of an exposure lamp through the scanning window to the document passed over the scanning window, projects a reflected light image from the document to a CCD sensor for the line scan, and reads an image of the document by repeating the line scan by the CCD sensor.

15. The apparatus of claim 14, wherein the CCD sensor outputs red image data R, green image data G, blue image data B, and black image data BK.

16. The apparatus of claim 15, wherein the adhering matter detecting section includes:
a monochrome converting section which converts the red image data R, the green image data G and the blue image data B outputted from the CCD sensor to one monochrome data when the scanning unit operates;
a differential value calculating section which, when reading of an image equivalent to one page by the scanning unit is completed, calculates a differential value between the monochrome data converted by the monochrome converting section and the black image data BK outputted from the CCD sensor, for each pixel in the read image equivalent to one page;
an average value calculating section which, when reading of an image equivalent to one page by the scanning unit is completed, adds each differential value calculated by the differential value calculating section, by each pixel in the direction of the line scan by the CCD sensor and divides the “added value by pixel” by the number of lines in the line scan for one page by the CCD sensor, thus calculating an “average value of differential values by pixel” in the direction of the line scan by the CCD sensor; and
a determining section which determines whether any of the image data of each pixel in the direction of the line scan by the CCD sensor includes the “image data of adhering matter” or not, on the basis of the “average value of differential values by pixel” calculated by the average value calculating section, and when the result of the determination is positive, determines a pixel of the image data including the “image data of adhering matter”.

17. The apparatus of claim 16, wherein when it is determined by the determining section that any of the image data of each pixel in the direction of the line scan by the CCD sensor includes the “image data of adhering matter” and the pixel of the image data including the “image data of adhering matter” is determined by the determining section, the adhering matter removing section corrects the image data of the determined pixel to image data that does not include the “image data of adhering matter” by linear interpolation.

18. The apparatus of claim 17, further comprising a control section which, when one kind of processing of enlargement, reduction, and rotation is carried out to the image read by the scanning unit, corrects the pixel of the image data including the “image data of adhering matter” determined by the determining section, along the performed processing.
